(19) United States
(12) Patent Application Publication
(10) Pub. No.: US 2019/0181439 A1
(43) Pub. Date: Jun. 13, 2019

(54) NEAR AMBIENT TEMPERATURE, HIGH POTENTIAL SECONDARY BATTERY WITH LIQUID ELECTRODE MATERIALS SEPARATED BY A SOLID ELECTROLYTE

(71) Applicants: THE BOARD OF TRUSTEES OF THE LELAND STANFORD JUNIOR UNIVERSITY, Stanford, CA (US); Jason Rugolo, Gilbert, AZ (US)

(72) Inventors: Jason RUGOLO, Gilbert, AZ (US); Antonio BACLIG, Stanford, CA (US); William CHUEH, Stanford, CA (US)

(21) Appl. No.: 16/324,111

(22) PCT Filed: Aug. 9, 2017
(86) PCT No.: PCT/US2017/046156

§ 371 Date: Feb. 7, 2019

Related U.S. Application Data
(60) Provisional application No. 62/373,266, filed on Aug. 10, 2016.

(51) Int. Cl. H01M 4/38; H01M 10/0562; H01M 10/0563

(52) U.S. Cl. CPC H01M 4/381; H01M 10/0562; H01M 2300/0068; H01M 2220/20; H01M 10/0563

(57) ABSTRACT

A secondary battery includes: 1) a negative electrode compartment including a molten metal negative electrode material which includes K; 2) a positive electrode compartment; and 3) an electrolyte disposed between the negative electrode compartment and the positive electrode compartment, wherein the electrolyte is an ion-conducting solid electrolyte.

### CROSS-REFERENCE TO RELATED APPLICATION

This application claims the benefit of U.S. Provisional Application No. 62/373,266, filed Aug. 10, 2016, the content of which is incorporated herein by reference in its entirety.

### BACKGROUND

The increasing deployment of renewable energy sources such as solar and wind power demands an increase in energy storage capacity for integration into an electrical power grid. Integrating these renewable energy sources with the grid is challenging because of their variability in output. Intermittent spikes or drops in power should be smoothed, and load balancing should be implemented to counter diurnal fluctuations. Inexpensive energy storage that is low cost and has long lifetime, high energy efficiency, and high safety, and that can be distributed throughout the grid is desired to allow broad penetration of solar, wind and other renewable energy sources. Unfortunately, current battery technologies are constrained in meeting the demands of the grid. For example, lead acid cells are relatively inexpensive and typically have low cycle life and low energy efficiency. Sodium-sulfur batteries typically operate at elevated temperatures, leading to higher costs for ancillary systems and reduced safety. Lithium-ion batteries used in electric vehicles are too costly for use on larger scales in the grid.

It is against this background that a need arose to develop embodiments of this disclosure.

### SUMMARY

Some embodiments of this disclosure relate to a secondary battery, which includes: 1) a negative electrode compartment including a molten metal negative electrode material which includes potassium (or K); 2) a positive electrode compartment; and 3) an electrolyte disposed between the negative electrode compartment and the positive electrode compartment, wherein the electrolyte is an ion-conducting solid electrolyte.

In some embodiments of the secondary battery, the molten metal negative electrode material includes K and at least one additional metal different from K.

In some embodiments of the secondary battery, the molten metal negative electrode material includes K and at least one additional alkali metal different from K.

In some embodiments of the secondary battery, the molten metal negative electrode material includes NaK. In some embodiments, a molar ratio of Na to K is in a range of about 10/90 to about 80/20.

In some embodiments of the secondary battery, the positive electrode compartment includes a liquid solution of a redox active species. In some embodiments, the liquid solution is an aqueous or non-aqueous solution of the redox active species. In some embodiments, the redox active species includes Br. In some embodiments, the redox active species includes Fe.

In some embodiments of the secondary battery, the ion-conducting solid electrolyte is a K⁺-conducting solid electrolyte. In some embodiments, the K⁺-conducting solid electrolyte includes a potassium aluminate. In some embodiments, the potassium aluminate includes K-β″-alumina.

In some embodiments of the secondary battery, the ion-conducting solid electrolyte is both K⁺-conducting and Na⁺-conducting.

In some embodiments of the secondary battery, the battery further includes a water protective coating on the ion-conducting solid electrolyte. In some embodiments, the water protective coating includes graphite.

In some embodiments of the secondary battery, the battery is configured to operate in a temperature range of about −10° C. to about 100° C.

In some embodiments of the secondary battery, the ion-conducting solid electrolyte is configured to transport K⁺ ions across the ion-conducting solid electrolyte during operation of the secondary battery.

In some embodiments of the secondary battery, the ion-conducting solid electrolyte is configured to transport Na⁺ ions across the ion-conducting solid electrolyte during operation of the secondary battery.

In some embodiments of the secondary battery, the molten metal negative electrode material includes NaK, and the positive electrode compartment includes a liquid solution of a redox active species which includes Br.

In some embodiments of the secondary battery, the molten metal negative electrode material includes NaK, and the positive electrode compartment includes a liquid solution of a redox active species which includes Fe.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1 shows a binary phase diagram for NaK as a function of molar ratio of Na and K (based on Bale, C. W. (1990). Binary Alloy Phase Diagrams, II Ed., Ed. T. B. Massalski, Vol. 3, 2376-2398).

FIG. 2 shows high stability of K-β″-alumina when in contact with NaK (about 50/50 molar ratio).

FIG. 3 shows an example embodiment of a supported thin film configuration of a solid electrolyte, in which a thin film of K-β″-alumina is supported on one side by a porous substrate including a metal coating, and with a water protective coating on another side.

FIG. 4 is a schematic of an example embodiment of a secondary battery implemented as a rechargeable battery.

FIG. 5 is a schematic of another example embodiment of a secondary battery implemented as a flow battery.

FIG. 6 shows (in an upper panel) relationships between specific capacity of a flow battery, as a function of concentration of Br species in a positive electrode solution and as a function of mole fraction of K in a negative electrode solution of NaK, and shows (in a lower panel) predicted operating voltage of the flow battery as a function of its specific capacity.

FIG. 7 shows cycling of a battery cell at a current density of about 1.9 mA/cm² for about 5-hour discharge and charge cycles, where concentrations on a positive electrode side were about 0.1 M K₄FeCN₆, about 0.1 M K₃FeCN₆, and about 1 M KOH and NaK on a negative electrode side had an about 50/50 molar ratio of Na/K.

FIG. 8 shows cycling of a battery cell at a current density of about 0.015 mA/cm² and voltage cutoffs of about 3.3 V to about 3.5 V, where concentrations on a positive electrode side were about 0.02 M K₄FeCN₆, about 0.02 M K₃FeCN₆, and about 1 M KOH and NaK on a negative electrode side had an about 50/50 molar ratio of Na/K.

FIG. 9 shows an open-circuit voltage (OCV) and an area-specific resistance (ASR) across a K-β″-alumina disc measured at different Na/K ratios in NaK and a positive electrode solution of about 0.1 M K₄FeCN₆, about 0.1 M K₃FeCN₆, and about 1 M KOH.

FIG. 10 shows a power density of battery cells at temperatures of about 22, about 41, and about 57° C.

FIG. 11 shows cycling of a battery cell at a current density of about 0.003 mA/cm² and voltage cutoffs of about 3.3 V to about 3.5 V.

### DESCRIPTION

Embodiments of this disclosure are directed to an improved secondary battery that includes a combination of molten metals at or near ambient temperatures at a negative electrode side, separated from a positive electrode side by a solid, ionically-conducting material. Some embodiments of the battery can be used for large-scale storage of electricity in a power grid or micro-grids, for services such as renewable energy integration, although other embodiments of the battery can be directed to applications such as vehicular transport.

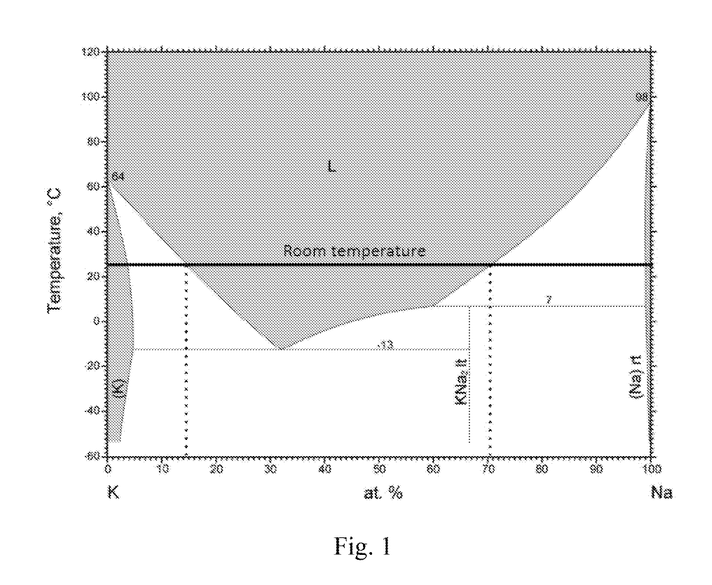

In some embodiments, a molten metal negative electrode material includes two or more different metals in the form of an alloy, a mixture, or other combination, such as two or more different alkali metals selected from lithium (or Li), sodium (or Na), potassium (or K), rubidium (or Rb), and cesium (or Cs). In some embodiments, one of the metals is K, and another one of the metals is an alkali metal different from K. In some embodiments, one of the metals is K, and another one of the metals is Na. In some embodiments, the molten metal negative electrode material is a source of potassium ions (K⁺) as mobile ions that are transported during battery operation. For example, the molten metal negative electrode material can include NaK as an eutectic alloy of Na and K, which is a liquid below room temperature (25° C.). FIG. 1 shows a binary phase diagram for NaK as a function of molar ratio of Na and K. The combination of Na and K lowers a solidification point below room temperature and below solidification points of either Na alone or K alone, and promotes battery operation at or near ambient temperatures. In some embodiments, a composition of NaK can be in a range from about 10/90 molar ratio of Na to K to about 80/20 molar ratio of Na to K, such as in a range from about 15/85 molar ratio to about 75/25 molar ratio or in a range from about 20/80 molar ratio to about 70/30 molar ratio. Other metals, such as other alkali metals or alkaline earth metals, can be added to change the NaK alloy's phase behavior if desired. In some embodiments, the molten metal negative electrode material can be substantially devoid of mercury (or Hg). It is also contemplated that the molten metal negative electrode material can consist essentially of, or consist of, K. It is further contemplated that the molten metal negative electrode material can be a source of sodium ions (Na⁺) as mobile ions that are transported during battery operation, or can be a source of both potassium ions (K⁺) and sodium ions (Na⁺) as mobile ions that are transported during battery operation.

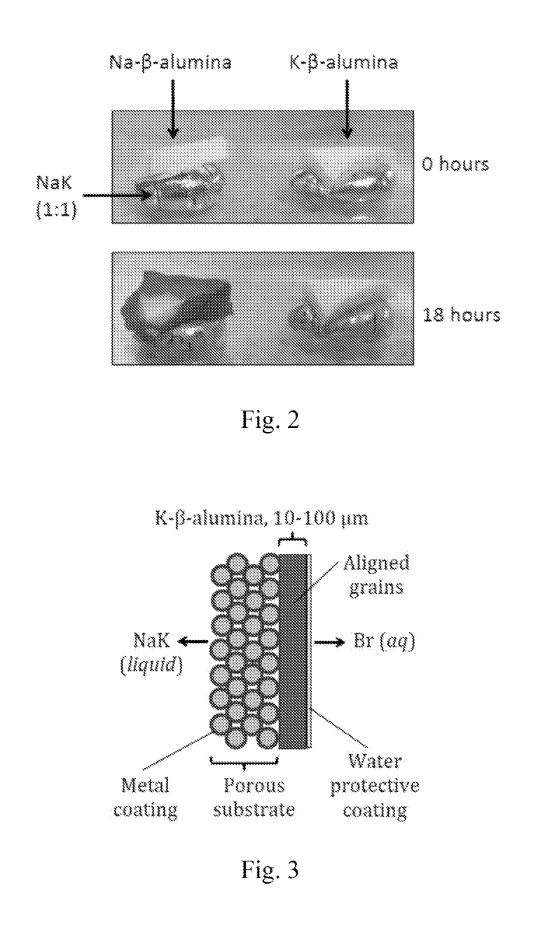

In some embodiments, a solid electrolyte is an ion-conducting solid ceramic electrolyte and, in particular, a K⁺-conducting solid ceramic electrolyte. For example, the solid electrolyte can include a potassium aluminate having a formula: K₁₊ₓAl₁₁O_{17+x/2}, which can include either, or both, a β phase (or potassium-beta-alumina or K-β-alumina) (0<x<0.67) and a β″ phase (or potassium-beta″-alumina or K-β″-alumina) (0.67≤x<1), and can optionally include a dopant stabilizer such as Li or magnesium (or Mg). K-β″-alumina provides benefits of being a solid and having stability when in contact with liquid electrode materials, as well as having requisite ionic conductivity. FIG. 2 shows high stability of K-β″-alumina when in contact with NaK (about 50/50 molar ratio) over a time period of about 18 hours, as compared to sodium-beta-alumina (or Na-β-alumina) which undergoes changes over the same time period. In some embodiments, the solid electrolyte including K-β″-alumina can be provided in the form of a disc. In some embodiments, the solid electrolyte can include K-β″-alumina as a supported thin film, such as having a thickness of about 100 microns or less to provide requisite ionic conductivity. FIG. 3 shows an example embodiment of a supported thin film configuration of the solid electrolyte, in which a thin film of K-β″-alumina having a thickness in a range of about 10 microns to about 100 microns is supported on one side by a porous substrate including a metal coating, and with a water protective coating on another side. The water protective coating can be a graphite coating or other carbonaceous coating. Other ionically-conducting materials can be used as the solid electrolyte. For example, it is also contemplated that the solid electrolyte can be a Na⁺-conducting solid electrolyte, or can be one that is both K⁺-conducting and Na⁺-conducting.

In some embodiments, a positive electrode material includes a liquid solution, such as an aqueous solution, with one or more redox active species which may or may not be dissolved in the solution. Examples of redox active species include chlorine (or Cl), bromine (or Br), iodine (or I), oxygen (or O), water (or H₂O), vanadium (or V), chromium (or Cr), manganese (or Mn), iron (or Fe), cobalt (or Co), nickel (or Ni), copper (or Cu), lead (or Pb), and organic redox active species (e.g., quinones), which can be in elemental form, molecular form, or both. For example, the positive electrode material can include an aqueous solution in which the redox active species is Br or another halogen, such as an aqueous solution of bromine and one or more bromide salts. In place of, or in addition to, water, another solvent can be used in which Na⁺, K⁺, BC, and Br₂ (or other redox active species) are sufficiently soluble. As another example, the positive electrode material can include an aqueous solution in which the redox active species is Fe or another transition metal, such as an aqueous solution of one or more iron salts, such as either, or both, potassium ferricyanide and potassium ferrocyanide. Other redox active materials can be used as the positive electrode material. An aqueous solution can have a high pH from the addition of a base, such as greater than about 7, or about 7.5 or greater, or about 8 or greater, or about 8.5 or greater, and up to about 14 or greater. It is also contemplated that other embodiments can include a non-aqueous liquid solution, such as an organic electrolyte, a molten salt, an ionic liquid, or a deep eutectic liquid.

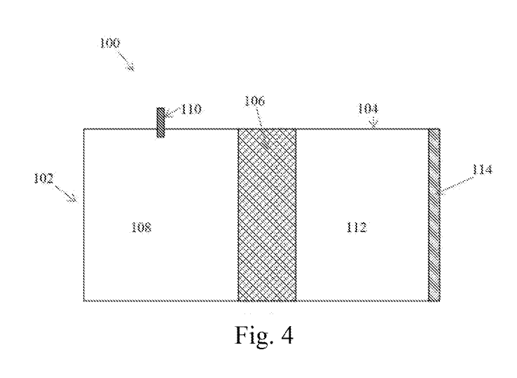

FIG. 4 is a schematic of an example embodiment of a secondary battery implemented as a rechargeable battery 100. The battery 100 includes a negative electrode compartment 102 and a positive electrode compartment 104, which are separated by a solid electrolyte 106. Included in the negative electrode compartment 102 is a molten metal negative electrode material 108, which can include NaK or another combination of molten metals previously discussed. As shown in FIG. 4, an electrical terminal 110 is included in the negative electrode compartment 102 to provide an electrical contact to the molten metal negative electrode material 108. NaK is electrically conductive, and can serve a dual purpose as a current collector and as an electrochemically active material, thereby allowing omission of a separate current collector. However, it is also contemplated that a current collector can be included in other embodiments. The solid electrolyte 106 can include K-β″-alumina or another ionically-conducting material. Included in the positive electrode compartment 104 is a positive electrode material 112, which can include an aqueous solution of Br or Fe or another redox active species previously discussed. As shown in FIG. 4, a current collector 114 is included in the positive electrode compartment 104. The current collector 114 can include a carbonaceous, electrically conductive cloth or sheet material, such as carbon felt, activated carbon fabric, or graphite, or can include a composite of a carbonaceous material and a polymer, such as a polyolefin, or can include a catalyst impregnated in a carbonaceous material. For example, bromine redox reaction is facile on graphite or another carbonaceous material, which is also relatively inexpensive and robust in electrochemical environments. In the case of implementing the battery 100 as NaK|K-β″-alumina|Br₂(aq), during discharge, K atoms are oxidized in the negative electrode compartment 102 to yield K⁺ ions, and bromine molecules are reduced in the positive electrode compartment 104, with K⁺ ions transported through the K-β″-alumina solid electrolyte 106. During charge, the operation is reversed.

Advantages of the battery 100 include:

1) Liquid electrode materials: The use of liquids can promote ease of scalability and low cost. Also, liquids generally lack a microstructure that can degrade with long-term cycling, and therefore their use can promote long lifetime.

2) High (open-circuit) voltage: The battery 100 can have an open-circuit voltage of at least about 2.5 V, at least about 3.0 V, at least about 3.4 V, at least about 3.5 V, at least about 3.55 V, at least about 3.6 V, at least about 3.65 V, at least about 3.7 V, at least about 3.75 V, at least about 3.8 V, at least about 3.85 V, at least about 3.9 V, or at least about 3.95 V, such as about 4 V or greater, about 4.05 V or greater, or about 4.1 V or greater. Higher voltage can translate into higher energy efficiency (aided by rapid kinetics of Br₂/Br⁻ redox, for example), higher power, higher power density, and higher energy density. For example, energy density can be at least about 15 Wh/kg, at least about 50 Wh/kg, at least about 100 Wh/kg, at least about 110 Wh/kg, at least about 120 Wh/kg, or at least about 130 Wh/kg, such as about 140 Wh/kg or greater. Other embodiments can be implemented as flow batteries, thus decoupling energy and power.

3) Near ambient temperature and pressure: Operating at or near ambient temperature and pressure can translate into higher energy efficiency and lower costs for ancillary systems, as well as improved safety, less corrosion, and greater operating flexibility. For example, the battery 100 can operate in a temperature range of about −10° C. to about 120° C., about −10° C. to about 110° C., about −10° C. to about 100° C., about 5° C. to about 120° C., about 10° C. to about 110° C., about 15° C. to about 100° C., about 20° C. to about 100° C., or about 50° C. to about 80° C., in which liquid electrode materials on both a negative electrode side and a positive electrode side remain liquids during battery cycling.

4) Solid electrolyte: The use of a solid electrolyte can reduce cross-over of active material and can increase mechanical robustness, thereby promoting long lifetime and improved safety.

5) High power and energy density: For example, energy density can be at least about 15 Wh/kg, at least about 50 Wh/kg, at least about 100 Wh/kg, at least about 110 Wh/kg, at least about 120 Wh/kg, or at least about 130 Wh/kg, such as about 140 Wh/kg or greater. Other embodiments can be implemented as flow batteries, thus decoupling energy and power.

6) Low cost: The use of earth-abundant materials as components of the battery 100 can promote low cost, thereby facilitating deployment for large-scale storage of electricity in a power grid or micro-grids.

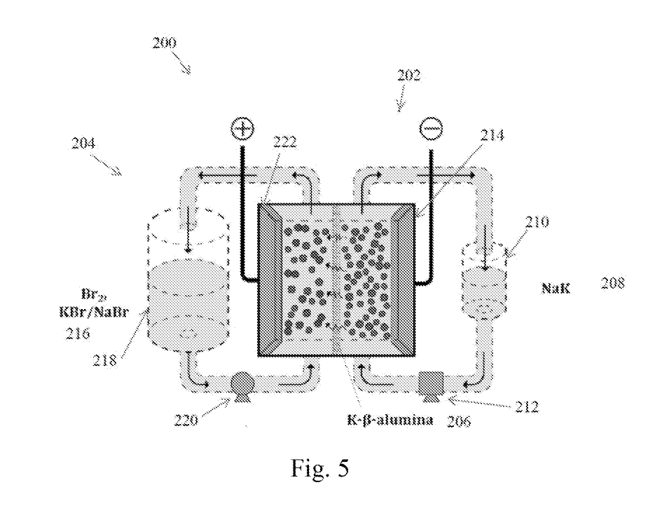

FIG. 5 is a schematic of another example embodiment of a secondary battery implemented as a flow battery 200. The battery 200 includes a negative electrode compartment 202 and a positive electrode compartment 204, which are separated by a membrane 206. A negative electrode solution 208 is conveyed by a conveyance mechanism that is fluidly connected to the negative electrode compartment 202; specifically, the negative electrode solution 208 is conveyed from a container 210 by a pump 212, and is circulated as a liquid reactant into the negative electrode compartment 202 across the membrane 206 and out of the negative electrode compartment 202. The negative electrode solution 208 can include NaK or another combination of molten metals previously discussed. Included in the negative electrode compartment 202 is a negative electrode 214, which can include a current collector. The membrane 206 can include K-β″-alumina or another ionically-conducting material. A positive electrode solution 216 is conveyed by another conveyance mechanism that is fluidly connected to the positive electrode compartment 204; specifically, the positive electrode solution 216 is conveyed from a container 218 by a pump 220, and is circulated as a liquid reactant into the positive electrode compartment 204 across the membrane 206 and out of the positive electrode compartment 204. The positive electrode solution 216 can include an aqueous solution of Br or Fe or another redox active species previously discussed. Included in the positive electrode compartment 204 is a positive electrode 222, which can include a current collector. During operation of the battery 200, K atoms are oxidized in the negative electrode compartment 202 to yield K⁺ ions, and bromine molecules are reduced in the positive electrode compartment 204, with K⁺ ions transported through the K-β″-alumina membrane 206.

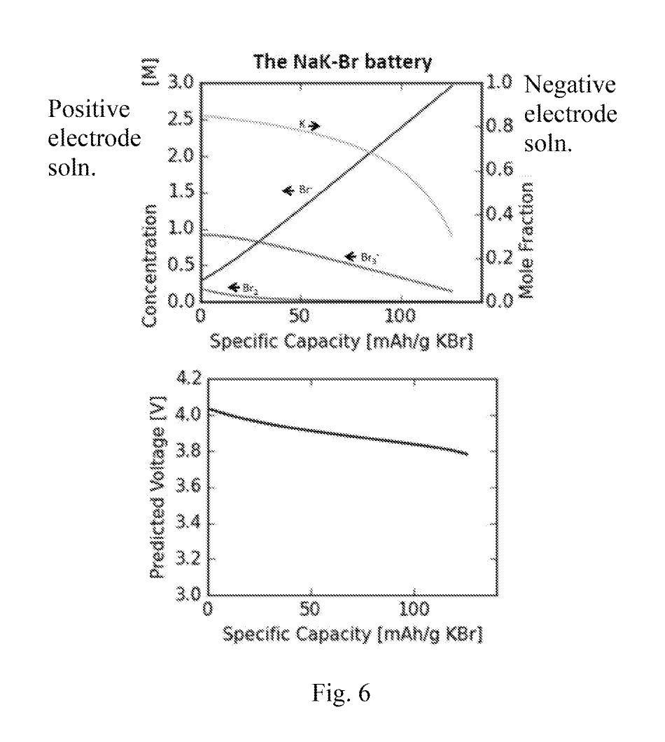

FIG. 6 shows (in an upper panel) relationships between specific capacity of a flow battery, such as the flow battery 200 of FIG. 5, as a function of concentration of Br species in a positive electrode solution and as a function of mole fraction of K in a negative electrode solution of NaK, and shows (in a lower panel) predicted operating voltage of the flow battery as a function of its specific capacity. As can be observed, the flow battery has a high (open-circuit) voltage of about 4 V or greater, which can promote high energy efficiency. Further advantages include the use of liquid reactants to promote ease of scalability, long lifetime, and low cost; ambient temperature and pressure operation to promote high energy efficiency and high safety; the use of earth-abundant materials to promote low cost, and the use of a solid, ionically-conducting material to promote long lifetime and high safety.

### EXAMPLES

The following examples describe specific aspects of some embodiments of this disclosure to illustrate and provide a description for those of ordinary skill in the art. The examples should not be construed as limiting this disclosure, as the examples merely provide specific methodology useful in understanding and practicing some embodiments of this disclosure.

### Example 1

Construction was performed of battery cells with NaK (about 50/50 molar ratio of Na/K) on a negative electrode side separated by an about 1-2 mm thick K-β″-alumina disc from a positive electrode side composed of about 1 M Br₂, saturated KBr aqueous solution. The battery cells demonstrated an open-circuit voltage of about 3.9 V.

### Example 2

Battery cells similar to those from Example 1 were constructed with a positive electrode side composed of about 1 M I₂, saturated KI aqueous solution. The battery cells demonstrated an open-circuit voltage of about 3.3 V.

### Example 3

Battery cells similar to those from Example 1 were constructed with a positive electrode side composed of about 1 M I₂, saturated KI propylene carbonate solution. The battery cells demonstrated an open-circuit voltage of about 2.8 V.

### Example 4

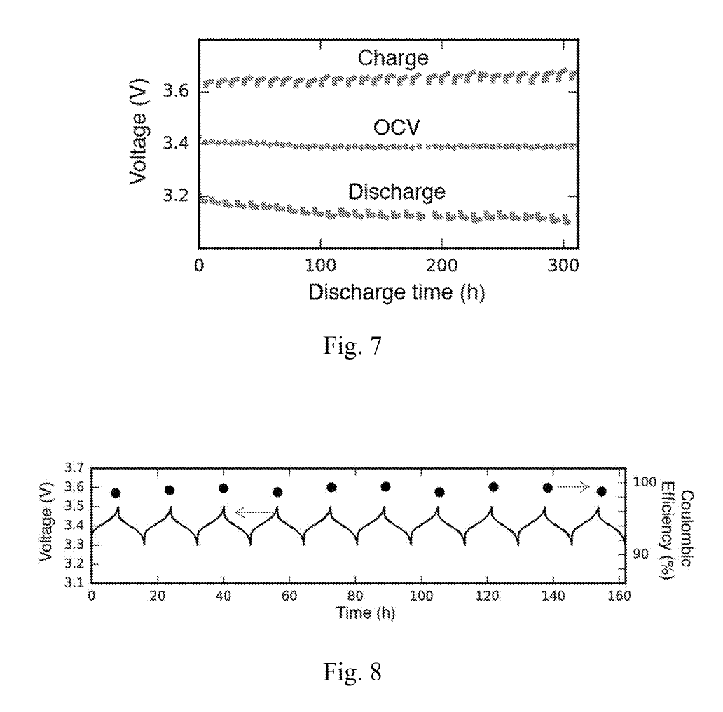

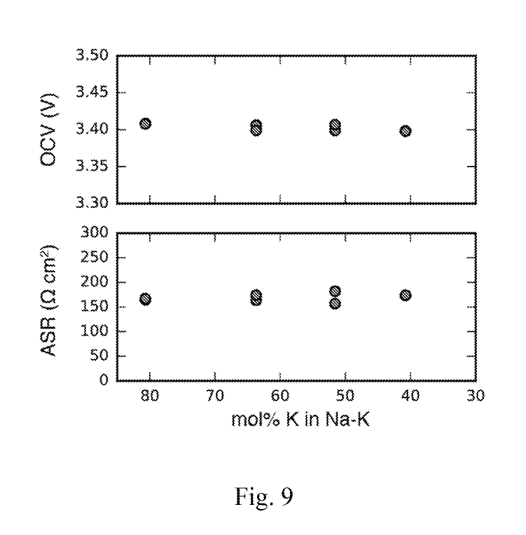

Construction was performed of battery cells with NaK on a negative electrode side separated by an about 2 mm thick K-β″-alumina disc from a positive electrode side composed of a potassium ferricyanide/ferrocyanide (K₃FeCN₆/K₄FeCN₆) and KOH aqueous solution. The battery cells demonstrated an open-circuit voltage of about 3.4 V, with resistances of about 100-200Ω·cm². FIG. 7 shows cycling of such a cell at a current density of about 1.9 mA/cm² for about 5-hour discharge and charge cycles, where concentrations on the positive electrode side were about 0.1 M K₄FeCN₆, about 0.1 M K₃FeCN₆, and about 1 M KOH and the NaK on the negative electrode side had an about 50/50 molar ratio. FIG. 8 shows cycling of such a cell at a current density of about 0.015 mA/cm² and voltage cutoffs of about 3.3 V to about 3.5 V, where concentrations on the positive electrode side were about 0.02 M K₄FeCN₆, about 0.02 M K₃FeCN₆, and about 1 M KOH and the NaK on the negative electrode side had an about 50/50 molar ratio of Na/K. FIG. 9 shows an open-circuit voltage (OCV) and an area-specific resistance (ASR) across the K-β″-alumina disc measured at different Na/K ratios in NaK and a positive electrode solution of about 0.1 M K₄FeCN₆, about 0.1 M K₃FeCN₆, and about 1 M KOH.

### Example 5

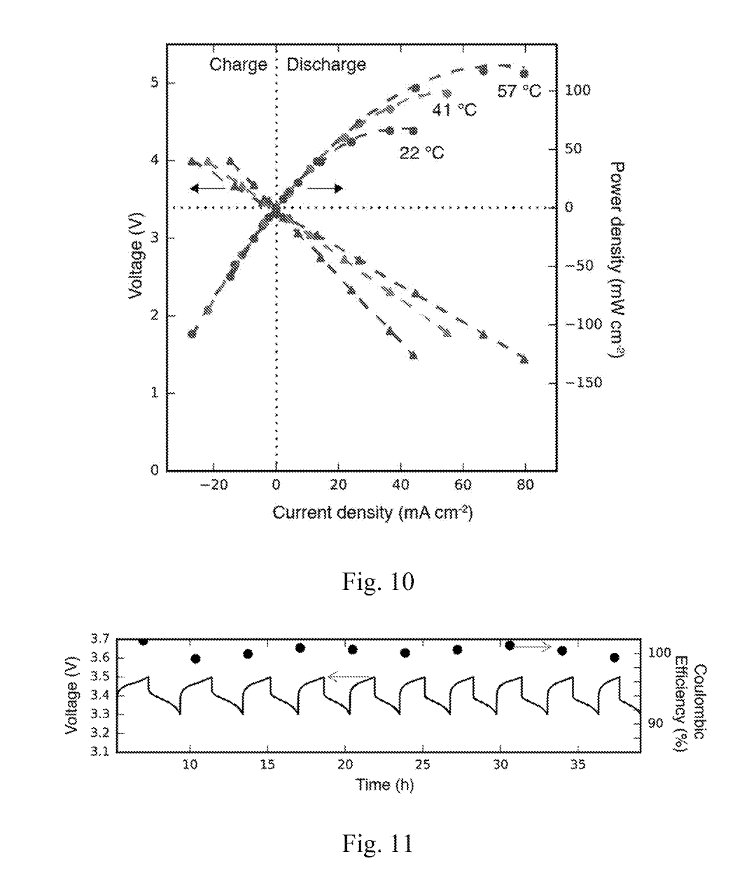

Construction was performed of battery cells with NaK (about 35/65 molar ratio of Na/K) on a negative electrode side separated by an about 0.33 mm thick K-β″-alumina disc from a positive electrode side composed of about 0.1 M K₄FeCN₆, about 0.1 M K₃FeCN₆, and about 1 M KOH. The cells were tested in an oven. FIG. 10 shows a power density of the cells at temperatures of about 22, about 41, and about 57° C.

### Example 6

Construction was performed of battery cells with NaK (about 50/50 molar ratio of Na/K) on a negative electrode side separated by an about 2 mm thick K-β″-alumina disc with a graphite coating from a positive electrode side composed of about 0.003 M K₃FeCN₆ and about 10⁻⁵ M KOH. The pH of the positive electrode side was measured to be about 8.5. FIG. 11 shows cycling of such a cell at a current density of about 0.003 mA/cm² and voltage cutoffs of about 3.3 V to about 3.5 V.

### Example 7

Construction was performed of NaK-NaK symmetrical battery cells separated by about 1-2 mm thick K-β″-alumina discs. The compositions of NaK ranged from about 20/80 molar ratio to about 70/30 molar ratio, with open-circuit voltages of about 0-10 mV demonstrated depending on particular compositions. These symmetrical cells had currents of about 1-5 mA/cm² passed for up to about 100 hours.

As used herein, the singular terms “a,” “an,” and “the” may include plural referents unless the context clearly dictates otherwise. Thus, for example, reference to an object may include multiple objects unless the context clearly dictates otherwise.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While this disclosure has been described with reference to the specific embodiments thereof, it should be understood by those skilled in the art that various changes may be made and equivalents may be substituted without departing from the true spirit and scope of this disclosure as defined by the appended claims. In addition, many modifications may be made to adapt a particular situation, material, composition of matter, method, operation or operations, to the objective, spirit and scope of this disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of this disclosure. Accordingly, unless specifically indicated herein, the order and grouping of the operations are not a limitation of this disclosure.

What is claimed is:

1. A secondary battery comprising:
a negative electrode compartment including a molten metal negative electrode material which includes K;
a positive electrode compartment; and
an electrolyte disposed between the negative electrode compartment and the positive electrode compartment, wherein the electrolyte is an ion-conducting solid electrolyte.

2. The secondary battery of claim 1, wherein the molten metal negative electrode material includes K and at least one additional metal different from K.

3. The secondary battery of claim 1, wherein the molten metal negative electrode material includes K and at least one additional alkali metal different from K.

4. The secondary battery of claim 1, wherein the molten metal negative electrode material includes NaK.

5. The secondary battery of claim 4, wherein a molar ratio of Na to K is in a range of about 10/90 to about 80/20.

6. The secondary battery of claim 1, wherein the positive electrode compartment includes a liquid solution of a redox active species.

7. The secondary battery of claim 6, wherein the liquid solution is an aqueous or non-aqueous solution of the redox active species.

8. The secondary battery of claim 6, wherein the redox active species includes Br.

9. The secondary battery of claim 6, wherein the redox active species includes Fe.

10. The secondary battery of claim 1, wherein the ion-conducting solid electrolyte is a K⁺-conducting solid electrolyte.

11. The secondary battery of claim 10, wherein the K⁺-conducting solid electrolyte includes a potassium aluminate.

12. The secondary battery of claim 11, wherein the potassium aluminate includes K-β″-alumina.

13. The secondary battery of claim 1, wherein the ion-conducting solid electrolyte is both K⁺-conducting and Na⁺-conducting.

14. The secondary battery of claim 1, further comprising a water protective coating on the ion-conducting solid electrolyte.

15. The secondary battery of claim 14, wherein the water protective coating includes graphite.

16. The secondary battery of claim 1, wherein the secondary battery is configured to operate in a temperature range of about −10° C. to about 100° C.

17. The secondary battery of claim 1, wherein the ion-conducting solid electrolyte is configured to transport K⁺ ions across the ion-conducting solid electrolyte during operation of the secondary battery.

18. The secondary battery of claim 1, wherein the ion-conducting solid electrolyte is configured to transport Na⁺ ions across the ion-conducting solid electrolyte during operation of the secondary battery.

19. The secondary battery of claim 1, wherein the molten metal negative electrode material includes NaK, and the positive electrode compartment includes a liquid solution of a redox active species which includes Br.

20. The secondary battery of claim 1, wherein the molten metal negative electrode material includes NaK, and the positive electrode compartment includes a liquid solution of a redox active species which includes Fe.
